(19) United States
(12) Patent Application Publication
(10) Pub. No.: US 2002/0082952 A1
(43) Pub. Date: Jun. 27, 2002

(54) Graphical user interface having a product matrix

(76) Inventor: Matthew Johnston, New York, NY (US)

Correspondence Address: BRINKS HOFER GILSON & LIONE, P.O. BOX 10395, CHICAGO, IL, 60610, US

(21) Appl. No.: 09/993,285

(22) Filed: Nov. 6, 2001

Related U.S. Application Data
(60) Provisional application No. 60/246,327, filed on Nov. 6, 2000.

(51) Int. Cl. G06F 17/60

(52) U.S. Cl. 705/27

(57) ABSTRACT

The present invention provides methods and systems for the purchase of furniture systems or products via a computer network such as the internet. In one aspect of the invention, a graphical user interface having a product matrix is provided to assist in the presentation and sale of furniture systems and products. In another aspect of the invention, a method and system for on-line purchase of a furniture system or furniture product is provided. Those skilled in the art will appreciate other aspects of the invention in view of the description below and with reference to the attached drawings.

### RELATED APPLICATION

This application claims the benefit of the filing date pursuant to 35 U.S.C. §119(e) of Provisional Application Serial No. 60/246,327, filed Nov. 6, 2000, the disclosure of which is hereby incorporated by reference.

### FIELD OF THE INVENTION

The present invention relates generally to methods and systems for the purchase of furniture systems or products via a computer network such as the internet. In particular, the present invention relates to a graphical user interface having a product matrix to assist in the presentation and sale of furniture systems and products.

### BACKGROUND OF THE INVENTION

The emergence of E-commerce has given businesses and consumers greater choice and flexibility in the marketplace. Web sites such as Priceline.com and Amazon.com have offered not only a greater variety of products and services, but have also offered the marketplace new methods of exchanging such products and services.

While there have been many advances in offering customers a wide range of products, little has been done to expand a customer's ability to purchase furniture over the internet. Moreover, there has been little or no development of a strategy for the convenient presentation of furniture products at a Web site.

In the past, small business or home office users have had generally limited options related to the purchase of office furniture. While many traditional retail stores carry office furniture, they are typically directed to the home user. In addition, these furniture products are typically of lower quality and functionality than some users may desire. While some higher end traditional designs are also available from other stores, many small business and home users seek a greater range of furniture selection options. Small businesses can also have problems because previously available furniture for such users could be unsuitable, both aesthetically and functional for particular office environments. In particular, many small businesses rely heavily on modern computer and phone technologies, such as many internet related businesses, thereby requiring more advanced furniture designs. Accordingly, while products having a higher level of functionality and quality are available, they were not readily available to many smaller businesses or home users.

As a result, while E-commerce has provided many new choices for customers, there still remains a need to develop new strategies for providing even better opportunities for the sale of furniture systems and products.

### SUMMARY OF THE INVENTION

The present invention provides methods and systems for the purchase of furniture systems or products via a computer network such as the Internet. In one aspect of the invention, a graphical user interface having a product matrix is provided to assist in the presentation and sale of furniture systems and products. In another aspect of the invention, a method and system for on-line purchase of a furniture system or furniture product is provided. Those skilled in the art will appreciate other aspects of the invention in view of the description below and with reference to the attached drawings.

### BRIEF DESCRIPTION OF THE DRAWINGS

FIG. 1 is a flow chart illustrating the operation of a preferred embodiment of a system operating in accordance with the present invention.

FIG. 2 is a display of a home page according to a preferred embodiment of the present invention.

FIG. 3 is a display of a product matrix page according to a preferred embodiment of the present invention.

FIG. 4 is a display of a product category page according to a preferred embodiment of the present invention.

FIG. 5 is a display of a product line page according to a preferred embodiment of the present invention.

FIG. 6 is a display is of a particular product page according to a preferred embodiment of the present invention.

FIG. 7 is a display of a product comparison page according to a preferred embodiment of the present invention.

### DETAILED DESCRIPTION OF THE INVENTION

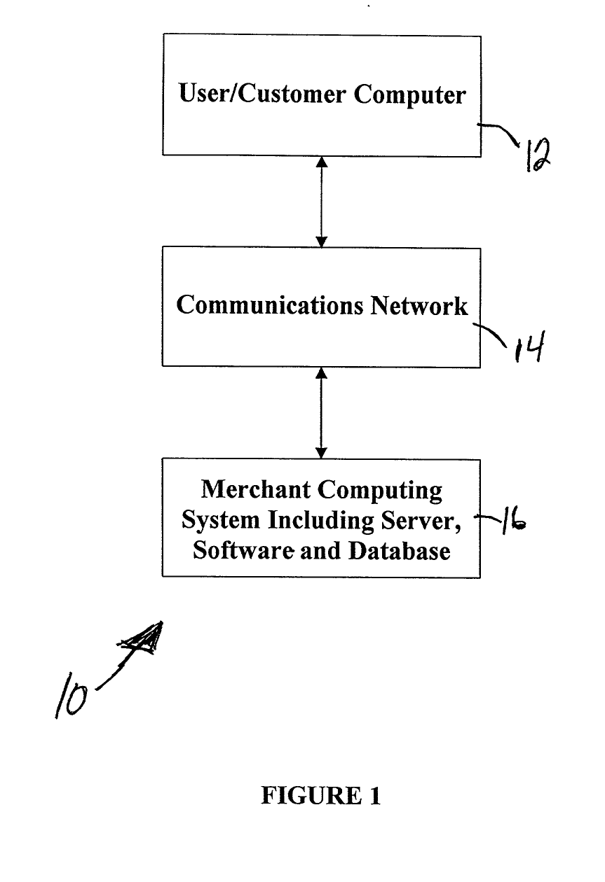

Referring initially to FIG. 1, a system for the selection and purchase of a furniture system is shown generally at 10. The system 10 includes a conventional user/customer computer 12, a communications network 14 such as the Internet, and a merchant computing system 16. As used herein, the terms “user” and “customer” are intended to be interchangeable. The merchant computing system 16 includes a server capable of running software. The server is also connected to a database that stores, for example, customer information, product information and the like. Customers such as small businesses or home users may access the server from their respective browsers via the communications network 14. The technical specifications generally concerning communications via the internet, as well as the software and formats used in client-server relationships, are now well known in the art, and therefore have not been included in the discussion that follows.

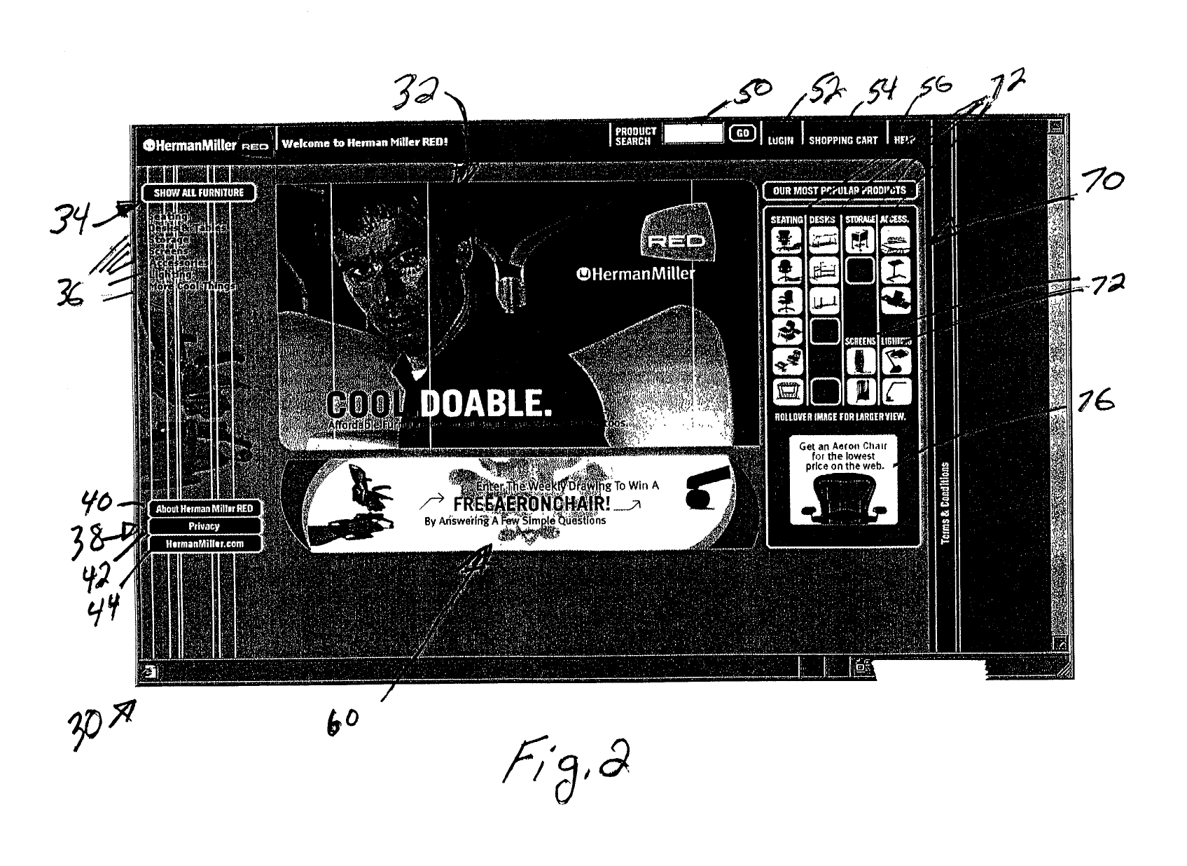

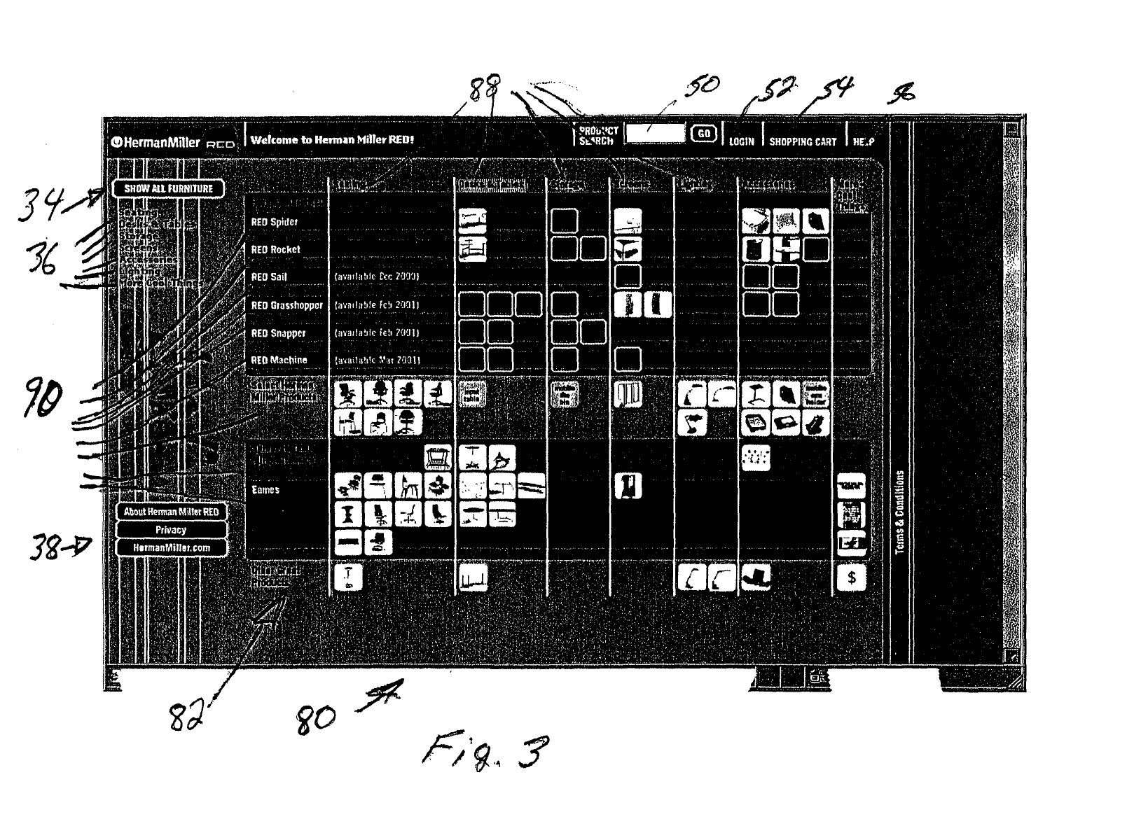

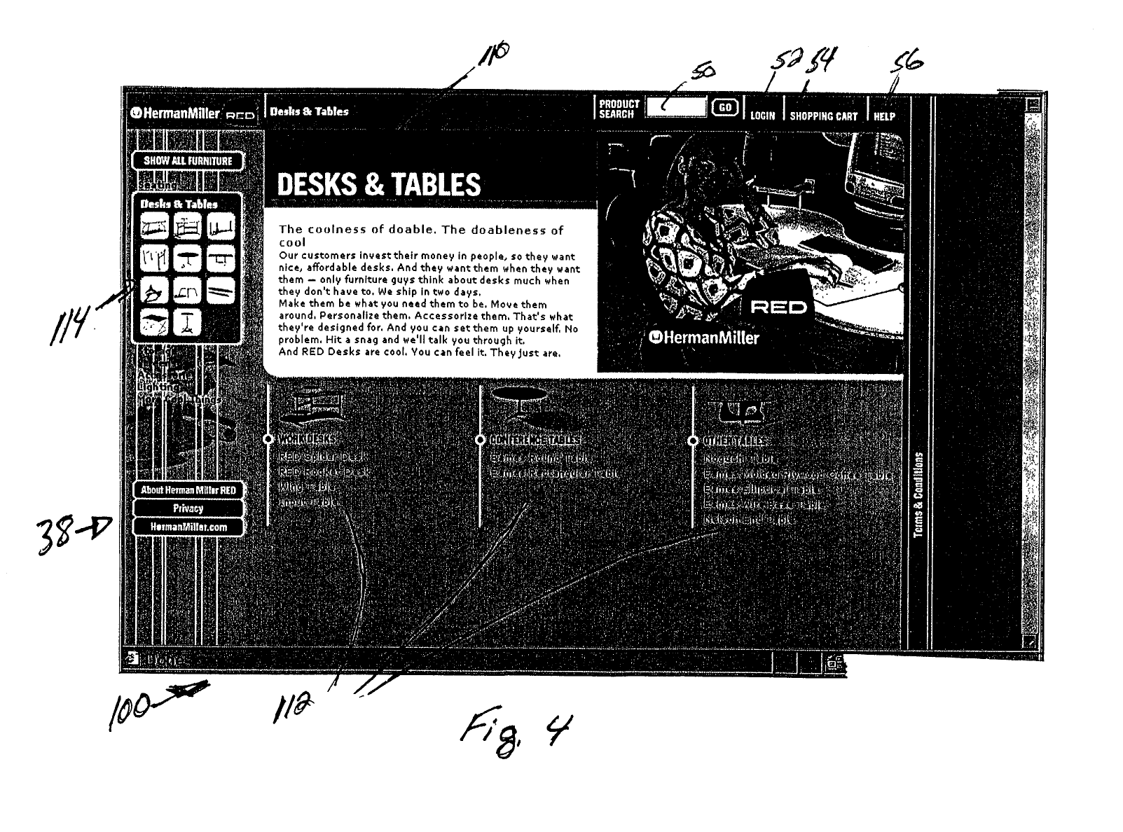

When a customer accesses the merchant computing system 16, he or she will typically first download the home page 30 which is illustrated in the preferred embodiment of FIG. 2. The home page 30 is an introduction to the products offered at the site. The lifestyle image 32 is an introduction to the character of the brand or products offered at the site. By selecting the “show all furniture products” button 34, a user will be directed to the product matrix page as illustrated in FIG. 3. By selecting one of the specific furniture categories 36 identified beneath the “show all furniture products” button 34, a user is directed to a product category page as illustrated in FIG. 4. The general information buttons 38 provide information about the brand 40, a statement on privacy 42 and a link 44 to a related home page. The general information buttons 38 are also located on additional pages throughout the site.

The search tool 50 allows a user to search for a particular product throughout the site, e.g., EAMES™ chairs. Adjacent the search tool 50, a customer login 52 is provided. The customer login button 52 provides a user with saved account information such as payment information, e.g., credit card information, in order to speed order processing. A password may be implemented with each customer account for security purposes. A shopping cart 54 provides a cart to identify products that a user desires to purchase. The adjacent help button 56 provides a list of frequently asked questions to assist a user of the site. The customer login button 52, the shopping cart 54 and the help button 56 are also located on additional pages in the site. A contest button 60 seeks customer demographic information in return for entry into a contest for a product such as the AERON™ chair.

A promotional matrix 70 is illustrated on the right hand side of the home page 30. The promotional matrix 70 illustrates the products sold the most according to the product categories 72. The product categories 72 include, in the illustrated embodiment: (1) seating, (2) desks, (3) storage, (4) accessories, e.g., keyboard supports, (5) screens, and (6) lighting. However, as those of skill in the art will recognize, the addition or deletion of other categories could be implemented. The organization of the promotional matrix 70 is important because it allows a user to look for the particular type of product desired, e.g., a chair, without having to look through various product lines to find chairs. The promotional matrix 70 also allows for the promotion of the most popular products. Alternatively, a user's or customer's history of purchases at the site may be tracked with the promotional matrix 70 identifying those products that were most often purchased by a particular customer.

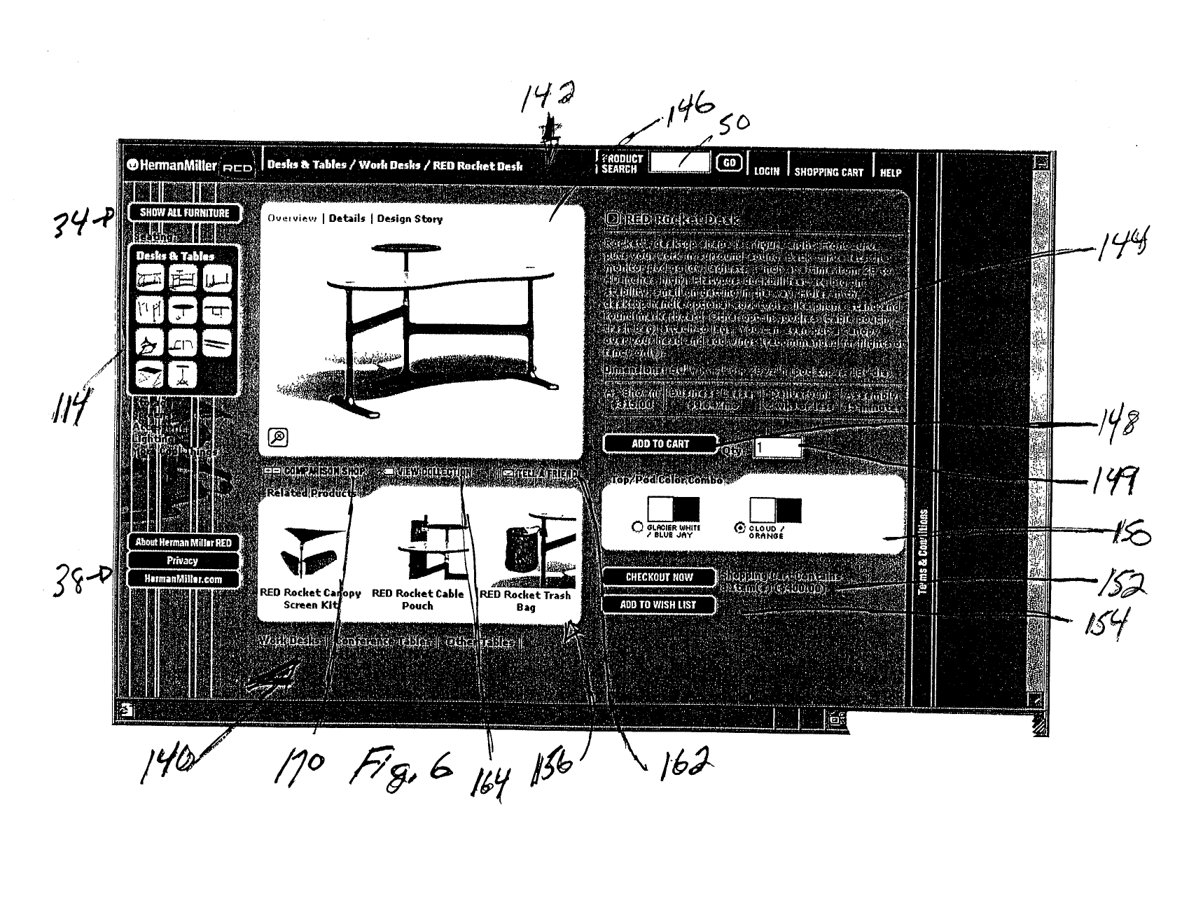

Within the product categories 72, thumbnail high resolution images of the particular products within the categories are illustrated. An enlarged image portion 76 provides an enlarged image of the particular products as the user scrolls the curser across the particular products. Accordingly, as a user scrolls down the seating product category 72, an enlarged image of each product will appear in the enlarged image portion 76. If a user desires to purchase a product or review additional information on a product, they simply click on the particular thumbnail image of the product in order to be directed to a product page as illustrated in FIG. 6. The above-identified products such the Herman Miller RED® products are all manufactured by Herman Miller, Inc. of Zeeland, Mich.

FIG. 3. illustrates a preferred embodiment of a product matrix page 80. By clicking on the “show all furniture products” button 34 of FIG. 2, a user is directed to the product matrix page 80. A preferred embodiment of a product matrix 82 is illustrated in the center of the page. The product matrix 82 is a single graphic representation of the product vocabulary. The product matrix columns are arranged according to product categories 88 as previously identified. The product matrix 82 also includes rows arranged according to product lines 90 such as: (1) RED Spider, (2) RED rocket, (3) RED sail, (4) RED grasshopper, (5) RED snapper, (6) RED machine, (7) Select Herman Miller Products, (8) Select Herman Miller Classics, (8) Eames products, and (9) Other Products. The product lines 90 are arranged, in a preferred embodiment, according to purchase price. In particular, the product lines 90 are arranged generally from least expensive to most expensive. As shown on the page 80, a thumbnail image of each particular product is arranged on the page according to the particular location defined by the above-identified parameters. Accordingly, a user or customer may view the entire product vocabulary on a single page.

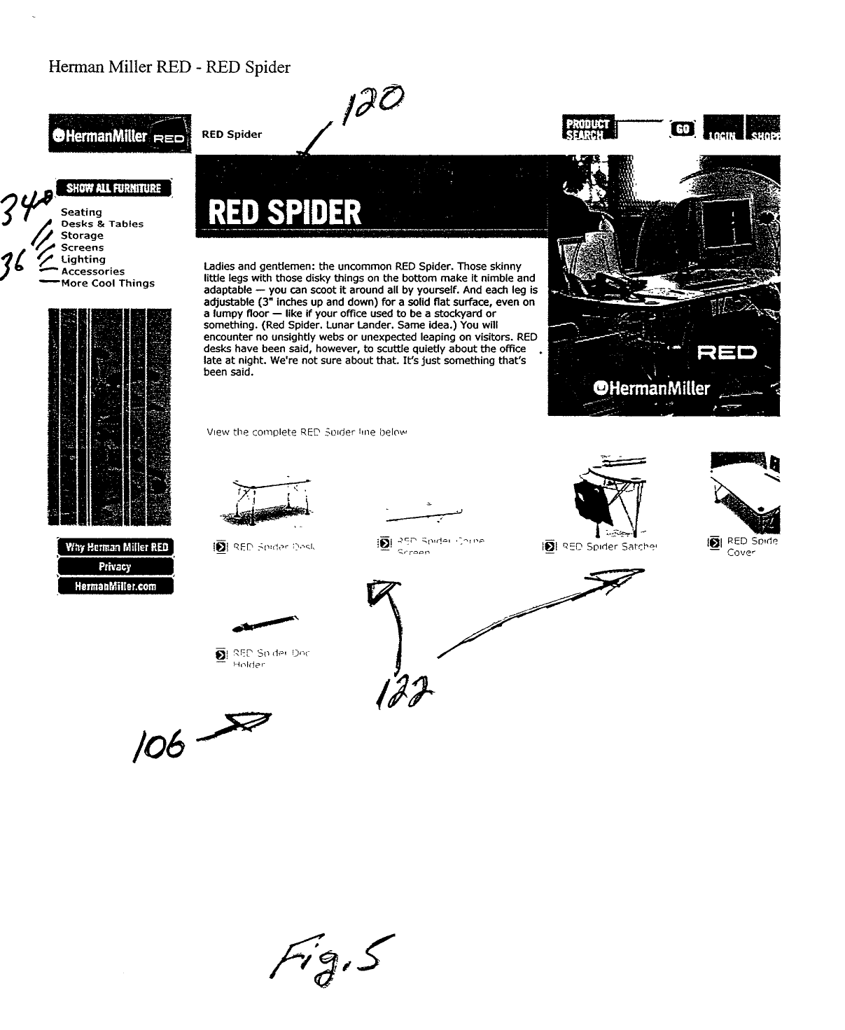

As operated on the home page 30, as a user scrolls across a particular product category 88 or product line 90, an enlarged representation of the product will appear on the page generally illustrated in FIG. 2. A user does not have to click on the image in order for the enlarged image to appear. As identified previously, if a user identifies a particular product they would like to purchase or gather more information on, they click on the thumbnail image of the desired product. Alternatively, a user may select a particular product category 88 in order to view a page, such as the embodiment of the product category page 100 illustrated in FIG. 4. A user may also select a product line 90 in order to view a product line page 106 such as that illustrated in the embodiment of FIG. 5. Accordingly, a user may easily define their search for a product by locating: (1) a particular product, (2) a particular product category, e.g. desks and tables or (3) a particular product line, e.g., RED SPIDER™. Also, the product lines 90 are arranged by purchase price in order to further aid the review of the vocabulary by a user.

The product matrix 82 generally requires the use of a limited product vocabulary. In particular, only a selected number of products may be identified in the product matrix, i.e., it cannot be continually expanded. The product matrix 82, in a preferred embodiment, should only include those products that have been sold in relatively high quantities. In the preferred embodiment, additional product lines 90 or particular products will be continually developed in order to replace products identified as underselling. Alternatively, the placement of products on the site may be based on those that are most profitable. In addition, many of the new product lines 90 will be developed with only a relatively small capital expenditure in order to insure that a generally constant development of new products for the site are produced.

Referring to FIG. 4, a preferred embodiment of a product category page 100 is illustrated. While the product category page 100 illustrates desks and tables, each product category will have a page. The main image and text at the central portion 110 identifies the particular product category, describes the category and includes an image of a representative product. The subcategories 112 further define the product categories into types of desks and tables, e.g., work desks, conference tables, and other tables such as EAMES™ or NOGUCHI™ tables. By clicking on a particular product identified in the subcategories, a user would be directed to a particular product page such as that illustrated in FIG. 6. A product category matrix 114 illustrates all the products in the particular product category, e.g., desks and tables. Again, by clicking on a particular product within the product category matrix 114, a user would be directed to a particular product page such as that illustrated in FIG. 6.

FIG. 5 illustrates a preferred embodiment of a product line page 106, e.g., RED SPIDER™. The product line page 106 illustrates a plurality of particular products according to a product line. The main image and text at the central portion of the page 120 identifies the particular product line, describes the product line and includes a representative image of the product. The product line is illustrates slightly enlarged product images 122. By clicking on a particular product in the collection of product images 122, a user would be directed to a product page 140 such as that illustrated in FIG. 6.

FIG. 6 illustrates a preferred embodiment of a product page 140. While page 140 is illustrated for the Red ROCKET™ desk, each product will have an associated page. The main image and text at the central portion 142 identifies the particular product, describes the product with the text 144 and includes an image 146 of the product. The text 144 includes, in a preferred embodiment, a description of the product, the dimensions of the product, the price, the leasing terms, the delivery time and assembly time. The “add to cart” button 148 allows a user to purchase the product by adding it to a shopping cart. In addition, the quantity button 149 allows a user to select the number of particular products desired. A color button 150 allows a user to select the desired color of the product. The “checkout now” button 152 allows a user to then purchase all the items present in their shopping cart. Alternatively, the “add to wish list” button 154 allows a user to save a list of items that they may like to purchase in the future. Related products image collection 156 identifies products related to the one identified above. Accordingly, a canopy, cable pouch or trash bag are shown as additional items that a user may desire to purchase together with the desk shown in FIG. 6.

A product category matrix 114 is again illustrated on the left hand side of the page as in FIG. 4. The product category matrix 114 keeps the related products in the same category readily accessible. Again, by clicking on a particular product within the product category matrix 114, a user would be directed to a particular product page.

The “tell a friend” button 162 allows for an email message to be created identifying the particular product and forwarding it to the friend. A link would then be presented in the email to allow the friend to quickly return to a particular product page, e.g., product page for the RED rocket desk as shown in FIG. 6. The “view collection” button 164 allows a user to switch to the product line page as illustrated in FIG. 5.

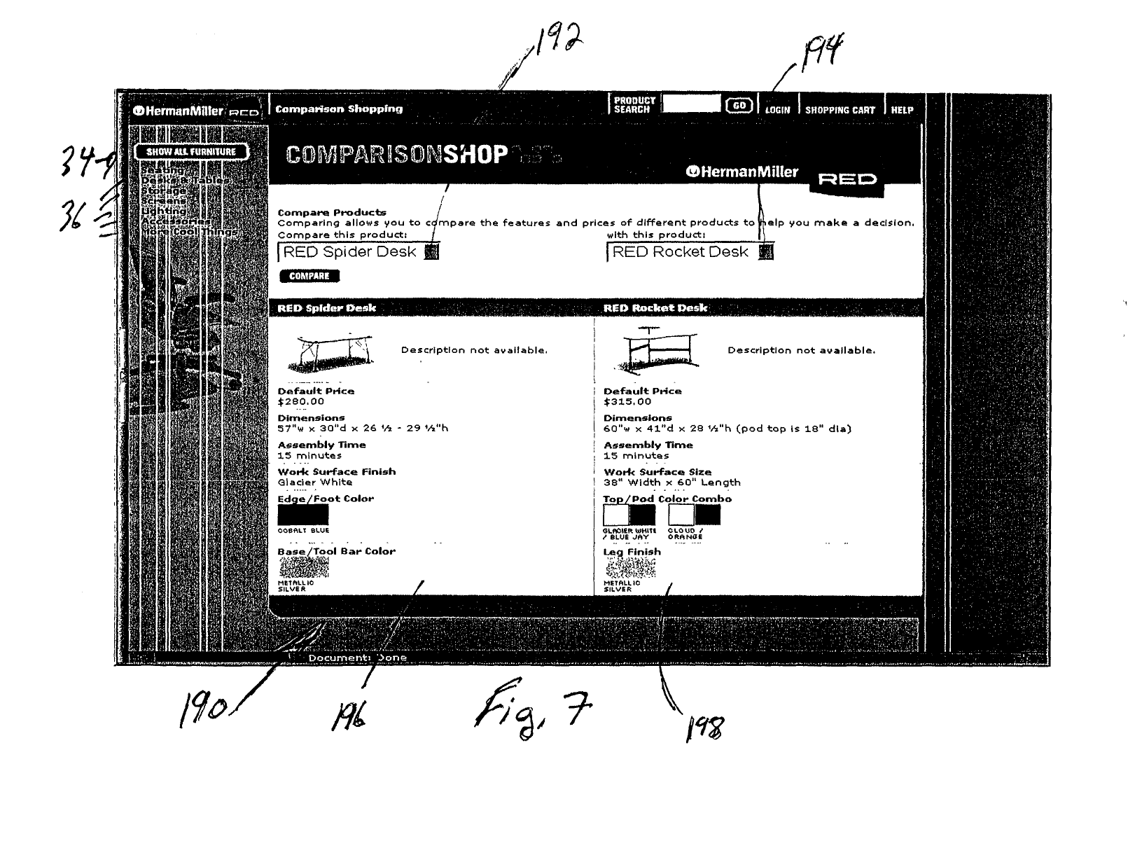

The comparison shop button 170 allows a user to be directed to a comparison shop page such as the preferred embodiment illustrated in FIG. 7. As illustrated in FIG. 7, a RED spider desk is being compared to a RED rocket desk. The menus 192 and 194 provide a quick listing of particular products than can be compared. A user may then easily adjust the particular products being compared, e.g., the wing table could also be compared to the RED rocket desk. The central portion of the screen, as illustrated in FIG. 7, is split into two categories 196 and 198, one for each product. Each of the categories 196 and 198 will include an image of the product, the price, the dimensions, the assembly time, the size, and color options. Accordingly, a user may easily compare the characters of two particular products.

Thus, those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

I claim:

1. A graphical user interface comprising:
a product matrix having rows and columns, each row defining one of a product category and a product line and each column defining the other of a product category and a product line wherein products are organized in the matrix according to product category and product line.

2. The graphical user interface of claim 1 wherein the rows define a product category and the columns define a product line.

3. The graphical user interface of claim 2 wherein the product category includes products selected from the group consisting of desks, storage and accessories.

4. The graphical user interface of claim 3 wherein an image of a first product is viewable at the intersection of a row and a column.

5. The graphical user interface of claim 4 wherein an enlarged image of a selected product is viewable simultaneously with the product matrix.

6. The graphical user interface of claim 5 further comprising a search tool.

7. The graphical user interface of claim 5 wherein the product lines are arranged by purchase price.

8. The graphical user interface of claim 7 wherein the product lines are arranged from least expensive to most expensive.

9. The graphical user interface of claim 8 wherein a computing system allows a user to select the product category, the product line or a particular product and view additional information about the product category, the product line or the particular product.

10. The graphical user interface of claim 9 wherein the additional information about the product category includes subcategories of related items.

11. The graphical user interface of claim 9 wherein the additional information about the product line includes information about the various products within a product line.

12. The graphical user interface of claim 9 wherein the additional information about the product includes information about at least one of a price and color of the particular product.

13. A system for providing a graphical user interface comprising:
logic that provides a viewable product matrix having rows and columns, each row defining one of a product category and a product line and each column defining the other of a product category and a product line wherein products are organized in the matrix according to product category and product line.

14. The system for providing a graphical user interface of claim 13 further comprising logic that displays rows that define a product category and columns that define a product line.

15. The system for providing a graphical user interface of claim 14 further comprising logic that displays an image of a first product viewable at the intersection of a row and a column.

16. The system for providing a graphical user interface of claim 15 further comprising logic that displays an enlarged image of a selected product viewable simultaneously with the product matrix image.

17. The system for providing a graphical user interface of claim 16 further comprising logic that displays the product lines arranged by purchase price.

18. The system for providing a graphical user interface of claim 17 wherein the logic displays the product lines arranged from least expensive to most expensive.

19. The system for providing a graphical user interface of claim 16 further comprising logic that allows a user to obtain additional information about a selected product category, product line or the particular product.

20. The system for providing a graphical user interface of claim 19 includes logic that provides additional information selected from the group consisting of price and color of the particular product.
